(19) United States
(12) Patent Application Publication
(10) Pub. No.: US 2024/0309784 A1
(43) Pub. Date: Sep. 19, 2024

(54) BREATHER CHAMBER STRUCTURE FOR INTERNAL COMBUSTION ENGINE

(71) Applicant: HONDA MOTOR CO., LTD., Tokyo (JP)

(72) Inventors: Hayato YAMASHIRO, Tokyo (JP); Noriyuki SUZUKI, Tokyo (JP); Akihiko MATSUKAWA, Tokyo (JP)

(21) Appl. No.: 18/603,216

(22) Filed: Mar. 13, 2024

(30) Foreign Application Priority Data
Mar. 16, 2023 (JP) 2023-041796

(51) Int. Cl. F01M 13/04; F02M 25/06

(52) U.S. Cl. CPC F01M 13/04; F02M 25/06; F01M 2013/0461

(57) ABSTRACT

Provided is a breather chamber structure for an internal combustion engine that is capable of increasing a passage length inside a breather chamber with a simple structure. A breather chamber structure for an internal combustion engine that is applicable to a breather chamber for temporarily storing, inside an internal combustion engine, blowby gas generated during operation of the internal combustion engine and to be recirculated to an intake passage, includes, in the breather chamber, a two-stage section formed by a first plate and a second plate that are attached to a rear surface side of a cylinder head cover attached to a cylinder head of the internal combustion engine and that are parallel with and spaced apart from each other, the two-stage section, and including a first chamber and a second chamber that are partitioned by the first plate.

This application is based on and claims the benefit of priority from Japanese Patent Application No. 2023-041796, filed on 16 Mar. 2023, the content of which is incorporated herein by reference.

### BACKGROUND OF THE INVENTION

### Field of the Invention

The present invention relates to a breather chamber structure for an internal combustion engine, and particularly to a breather chamber structure for an internal combustion engine for temporarily storing, inside the internal combustion engine, blowby gas generated during operation of the internal combustion engine and to be recirculated to an intake passage.

### Related Art

In recent years, research and development regarding improvement in fuel efficiency that contributes to an increase in energy efficiency has been carried out in order to ensure many people have access to affordable, reliable, sustainable, and advanced energy. In this regard, it has been known to provide, in a configuration for recirculating blowby gas generated during operation of an internal combustion engine, a breather chamber for temporarily storing the blowby gas inside the internal combustion engine in order to facilitate oil separation from the blowby gas.

Japanese Unexamined Patent Application, Publication No. 2008-223596 discloses a technology of providing a breather chamber as a storage space surrounded by a cylinder head cover attached to an upper portion of a cylinder head of an internal combustion engine and by a plate attached to a rear surface side of the cylinder head cover.

Patent Document 1: Japanese Unexamined Patent Application, Publication No. 2008-223596

### SUMMARY OF THE INVENTION

Incidentally, it is desired to increase the passage length inside a breather chamber in order to promote oil separation from blowby gas and allow a larger amount of clean fuel to be recirculated to an intake passage in the present technology related to an improvement of fuel efficiency. However, in order to provide a breather chamber having a longer passage length by using a single plate as in Japanese Unexamined Patent Application, Publication No. 2008-223596, the plate needs to formed into a complicated shape.

In order to overcome the above disadvantage, an object of the present invention is to provide a breather chamber structure for an internal combustion engine that is capable of increasing a passage length inside a breather chamber with a simple structure. Also, the present invention thus contributes to an increase in energy efficiency.

In order to achieve the above object, the present invention has a first feature directed to a breather chamber structure for an internal combustion engine, the breather chamber structure being applicable to a breather chamber (90) for temporarily storing, inside an internal combustion engine (1), blowby gas (G) generated during operation of the internal combustion engine (1) and to recirculated to an intake passage. The breather chamber structure includes, in the breather chamber (90), a two-stage section (80) formed by a first plate (60) and a second plate (70) that are attached to a rear surface side of a cylinder head cover (2) attached to a cylinder head (3) of the internal combustion engine (1) and that are parallel with and spaced apart from each other, the two-stage section (80) including a first chamber (A) and a second chamber (B) that are partitioned by the first plate (60).

The present invention has a second feature in which the breather chamber (90) includes the first chamber (A) into which the blowby gas (G) is introduced first, the second chamber (B) into which the blowby gas (G) is introduced from the first chamber (A), and a third chamber (C) into which the blowby gas (G) is introduced from the second chamber (B), the third chamber (C) is disposed on a lateral side of the two-stage section (80), the third chamber (C) is provided with a discharge pipe (31) that discharges the blowby gas (G) to outside of the internal combustion engine (1), and a height dimension of the third chamber (C) is greater than a height dimension of each of the first chamber (A) and the second chamber (B).

The present invention has a third feature in which the breather chamber structure further includes a communication passage (20) that establishes communication between the second chamber (B) and the third chamber (C), and the discharge pipe (31) is disposed at a position at which the discharge pipe (31) does not overlap with the communication passage (20) when viewed in a direction from the third chamber (C) toward the second chamber (B).

The present invention has a fourth feature in which a lower end of the discharge pipe (31) is at a position lower than the first plate (60) in a side view of the internal combustion engine (1).

Furthermore, the present invention has a fifth feature in which the second plate (70) has a larger area than the first plate (60).

The first feature makes it possible to increase the passage length inside the breather chamber by providing the two-stage section in the breather chamber by means of a simple configuration in which the two plates are attached to the rear surface side of the cylinder head cover, because the breather chamber structure for an internal combustion engine, which is applicable to the breather chamber (90) for temporarily storing, inside the internal combustion engine (1), the blowby gas (G) generated during operation of the internal combustion engine (1) and to be recirculated to the intake passage, includes, in the breather chamber (90), the two-stage section (80) formed by the first plate (60) and the second plate (70) that are attached to a rear surface side of a cylinder head cover (2) attached to a cylinder head (3) of the internal combustion engine (1) and that are parallel with and spaced apart from each other, and including the first chamber (A) and the second chamber (B) that are partitioned by the first plate (60). It is thus possible to promote oil separation from the blowby gas.

The second feature makes it possible to reduce the amount by which the discharge pipe provided in the third chamber projects from an upper surface of the cylinder head cover because the breather chamber (90) includes the first chamber (A) into which the blowby gas (G) is introduced first, the second chamber (B) into which the blowby gas (G) is introduced from the first chamber (A), and the third chamber (C) into which the blowby gas (G) is introduced from the second chamber (B), the third chamber (C) is disposed on the lateral side of the two-stage section (80), the third chamber (C) is provided with the discharge pipe (31) that discharges the blowby gas (G) to outside of the internal combustion engine (1), and the height dimension of the third chamber (C) is greater than the height dimension of each of the first chamber (A) and the second chamber (B).

The third feature makes it possible to increase the passage length from the second chamber to the discharge pipe of the third chamber because the communication passage (20) that establishes communication between the second chamber (B) and the third chamber (C) is included, and the discharge pipe (31) is disposed at a position at which the discharge pipe (31) does not overlap with the communication passage (20) when viewed in a direction from the third chamber (C) toward the second chamber (B).

The fourth feature makes it possible to increase the passage length, to reduce the amount by which the discharge pipe projects from the cylinder head cover, and to reduce the size of the cylinder head cover because the lower end of the discharge pipe (31) is at a position lower than the first plate (60) in a side view of the internal combustion engine (1).

The fifth feature makes it possible to simply configure the first chamber, the second chamber, and the third chamber in the breather chamber and to prevent erroneous assembly when the cylinder head cover is assembled because the area of the second plate (70) is larger than the area of the first plate (60).

### BRIEF DESCRIPTION OF THE DRAWINGS

FIG. 1 is a right side view of an internal combustion engine to which a breather chamber structure according to a present embodiment is applied;

FIG. 2 is a plan view of a cylinder head cover seen from an upper side of the internal combustion engine;

FIG. 3 is a rear view of the cylinder head cover seen from a rear surface side;

FIG. 4 is a schematic view illustrating a structure of a breather chamber according to the present embodiment;

FIG. 5 is a rear view illustrating a state where a first plate is attached to the cylinder head cover;

FIG. 6 is a rear view illustrating a state where a second plate is attached to the cylinder head cover;

FIG. 7 is a sectional view along the line VII-VII in FIG. 6;

FIG. 8 is a sectional view along the line VIII-VIII in FIG. 6; and

FIG. 9 is a sectional view along the line IX-IX in FIG. 6.

### DETAILED DESCRIPTION OF THE INVENTION

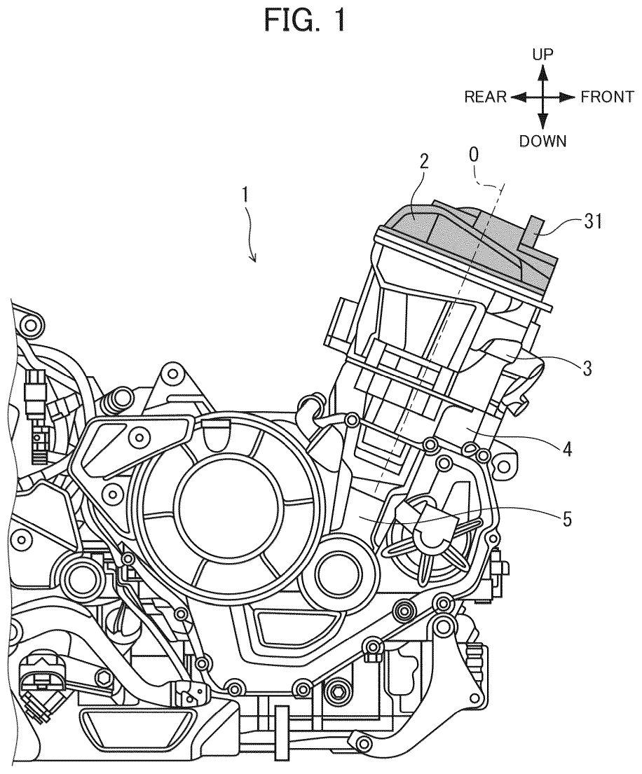

A preferred embodiment of the present invention will be described below in detail with reference to the drawings. FIG. 1 is a right side view of an internal combustion engine 1 to which a breather chamber structure according to the present embodiment is applied. The internal combustion engine 1 according to the present embodiment is a four-cycle parallel twin engine that is applied as a power unit for a straddle-type vehicle. The internal combustion engine 1 is attached to the straddle-type vehicle in an illustrated posture, and direction arrows in the drawing are illustrated with reference to the posture of the straddle-type vehicle with the internal combustion engine 1 attached thereto.

A cylinder 4 that accommodates a piston sliding up and down along a cylinder axis O is integrally formed with an upper portion of a crankcase 5 that accommodates a crankshaft and a transmission. A cylinder head 3 that accommodates an intake/exhaust mechanism including an intake/exhaust valve, a camshaft, and the like is attached to an upper portion of the cylinder 4, and a cylinder head cover 2 (gray colored portion in the drawing) is attached to an upper portion of the cylinder head 3.

A discharge pipe 31 for discharging blowby gas generated with operating of the internal combustion engine 1 to outside is attached to an upper portion of the cylinder head cover 2 that is formed of a thin plate member such as metal, a synthetic resin, or the like. A breather chamber to which the breather chamber structure according to the present embodiment is applied is formed inside the cylinder head cover 2.

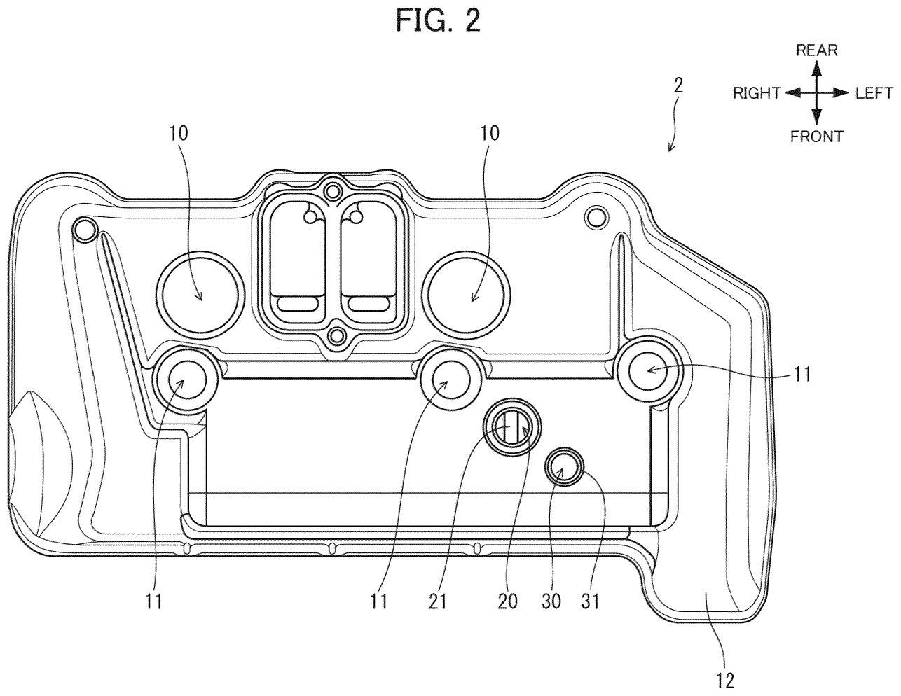

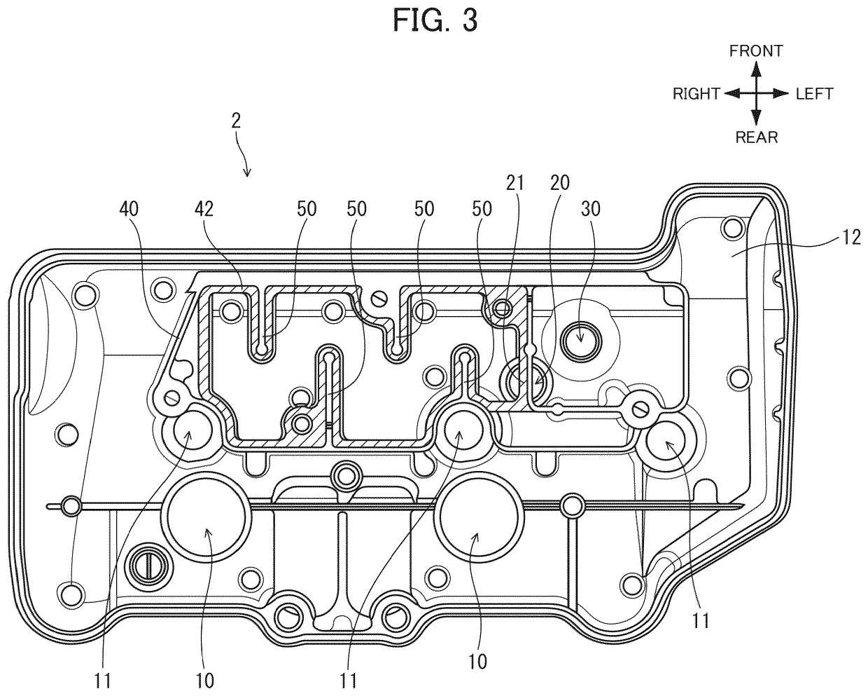

FIG. 2 is a plan view of the cylinder head cover 2 seen from a cylinder axis upper side of the internal combustion engine 1. Also, FIG. 3 is a rear view of the cylinder head cover 2 seen from the rear surface side. Three through-holes 11 through which bolts for fixing the cylinder head cover 2 to the cylinder head 3 pass and two through-holes 10 through which ignition plugs pass are formed in the cylinder head cover 2. An extension portion 12 that extends forward in a manner corresponding to a shape of a cam chain tunnel provided in the cylinder head 3 is formed at a left end of the cylinder head cover 2.

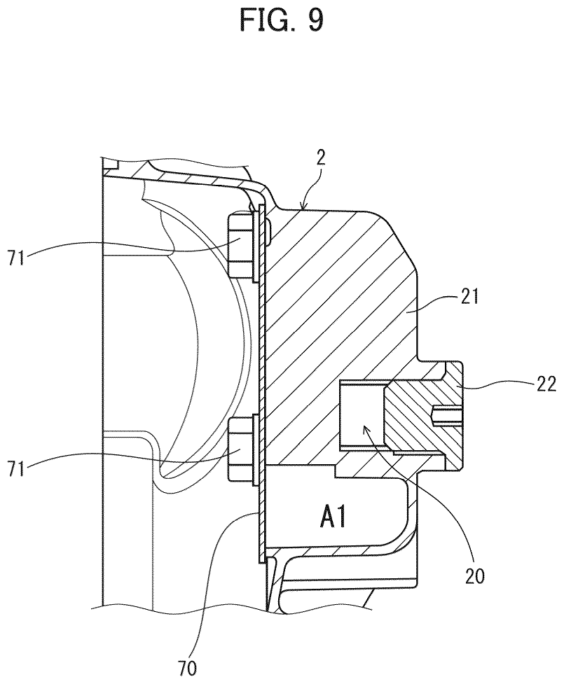

A communication passage 20 that establishes communication between a second chamber and a third chamber in the breather chamber, which will be described later, is formed on a left obliquely front side of the through-hole 11 at the center. The communication passage 20 is provided in a partition wall 21 that partitions the second chamber from the third chamber. A lid is put on the through-hole by a cap member (see FIG. 9) when the cylinder head cover 2 is assembled. A discharge hole 30 to which the discharge pipe 31 is attached is formed on a left obliquely front side of the communication passage 20.

Referring to FIG. 3, a breather chamber including a first chamber, the second chamber, and the third chamber is configured by two plates being attached to the rear surface of the cylinder head cover 2 such that the two plates are parallel with and spaced apart from each other, in the breather chamber structure according to the present embodiment. An inner rib 42 (the oblique line hatched portion in the drawing) that is provided to stand for attachment of a first plate and an outer rib 40 that is provided to stand for attachment of a second plate are formed on the rear surface side of the cylinder head cover 2.

In the present embodiment, the second chamber is configured by the first plate being caused to abut and fixed to the inner rib 42, and the first chamber and the third chamber are configured by the second plate being caused to abut and fixed to the outer rib 40. Four partition walls 50 to provide labyrinth structures inside the first chamber and the second chamber are formed integrally with the outer rib 40.

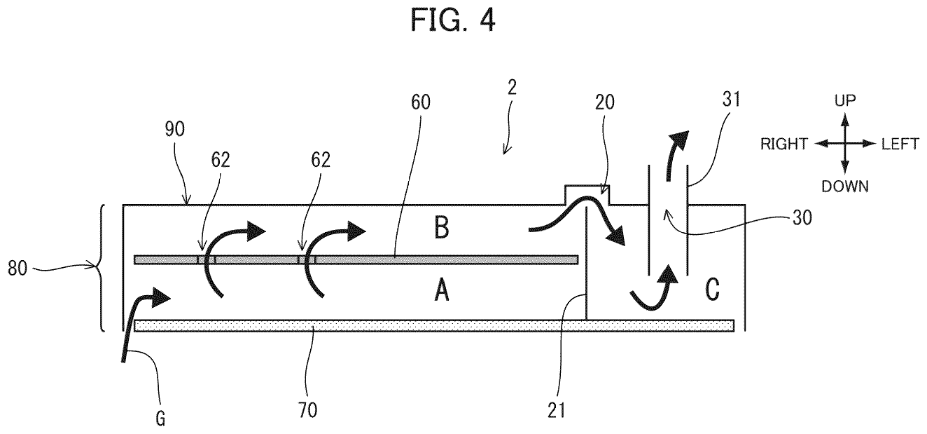

FIG. 4 is a schematic view illustrating the structure of the breather chamber according to the present embodiment. As described above, the breather chamber 90 including the first chamber A, the second chamber B, and the third chamber C is configured by the first plate 60 (the gray colored portion in the drawing) and the second plate 70 (the dot hatched portion in the drawing) being attached to the rear surface side of the cylinder head cover 2 such that the first plate 60 and the second plate 70 are parallel with and spaced apart from each other in the present invention.

In the present embodiment, the configuration of the breather chamber 90 from the three rooms enables absorption of pressure variations of the blowby gas G and oil separation from the blowby gas G to be efficiently performed. The first plate 60 and the second plate 70 are made of thin plate members with constant thicknesses.

The first chamber A and the second chamber B partitioned by the first plate 60 are stacked in the direction of the cylinder axis O and configure a two-stage section 80. The third chamber C is provided on a lateral side of the two-stage section 80. The blowby gas G introduced into the first chamber A from a gap provided between the cylinder head cover 2 and the first plate 60 is guided to the second chamber B through a plurality of openings 62 provided in the first plate 60. The blowby gas G introduced into the second chamber B is guided to the third chamber C through the communication passage 20 provided in the partition wall 21. The blowby gas G introduced into the third chamber C is guided to a part below the discharge pipe 31 attached to the discharge hole 30 and is then discharged to outside of the internal combustion engine 1 through the discharge pipe 31.

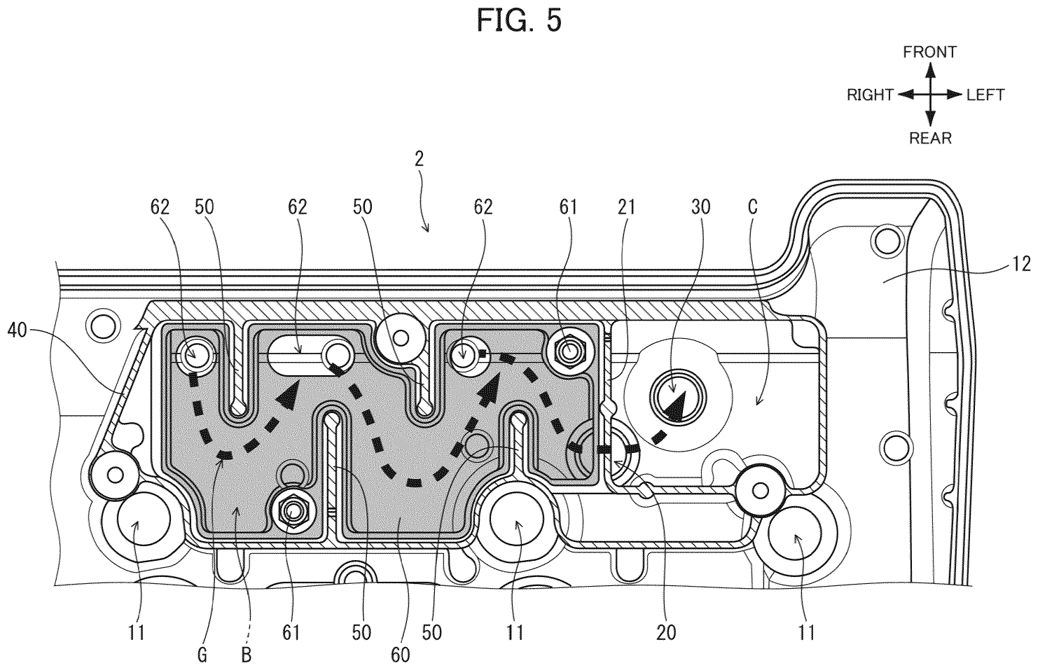

FIG. 5 is a rear view illustrating a state where the first plate 60 is attached to the cylinder head cover 2. Although the first plate 60 is formed of metal, a hard resin, or the like, the first plate 60 is illustrated as a semi-transparent member that is colored with gray for explanation in the drawing.

The second chamber B of the breather chamber 90 is configured by attaching the first plate 60 to the cylinder head cover 2. The first plate 60 is fixed with two bolts 61. Three openings 62 are formed in the first plate 60, and the blowby gas G guided to the second chamber B from the first chamber A (see FIG. 4) through the openings 62 passes through the labyrinth structure formed by the partition walls 50 and is then guided to the communication passage 20. The blowby gas G guided from an upper end side of the third chamber C through the communication passage 20 is introduced from the lower side of the discharge pipe 31 and is then discharged upward. In this manner, a plurality of structures for increasing the passage length in the breather chamber 90 are applied to the part from the second chamber B to the third chamber C as well.

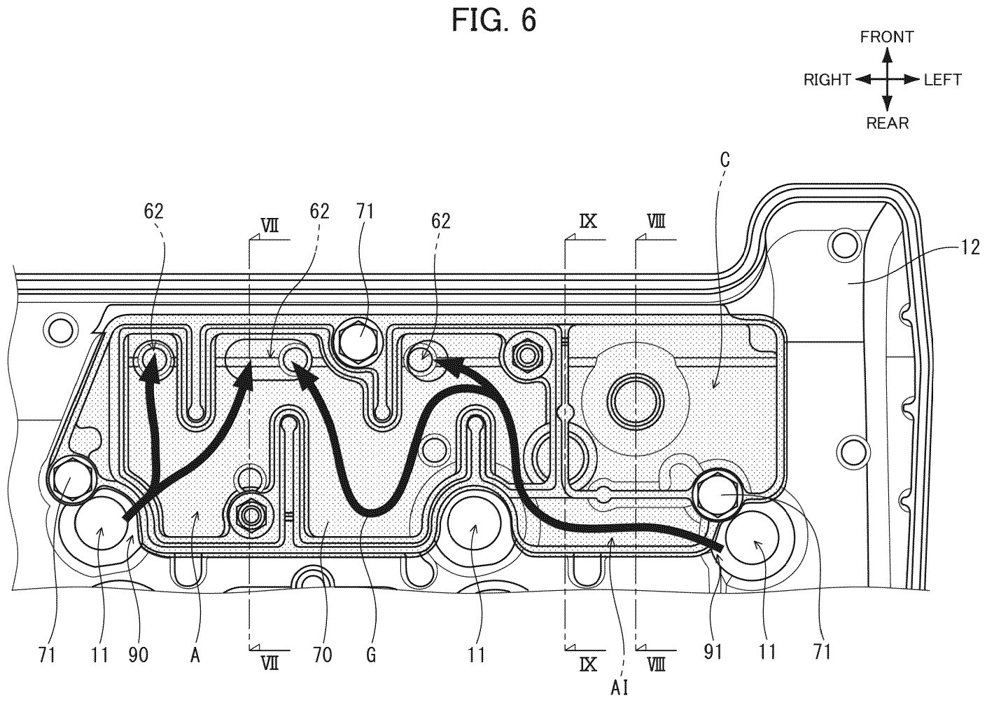

FIG. 6 is a rear view illustrating a state where the second plate 70 is attached to the cylinder head cover 2. Although the second plate 70 is formed of metal, a hard resin, or the like, the second plate 70 is illustrated as a semi-transparent member that is dot-hatched in this drawing for explanation. The second plate 70 with a larger area than the first plate 60 covers the entire first plate 60 and further has a shape with a dimension extended in the left direction, in particular.

The first chamber A and the third chamber C of the breather chamber 90 are configured by attaching the second plate 70 in contact with a ceiling surface of the outer rib 40. The second plate 70 is fixed with three bolts 71. The first chamber A communicates with a horizontally long expanded portion A1 that is adjacent to a rear side (the lower side in the drawing) of the third chamber.

The blowby gas G generated with operating of the internal combustion engine 1 is guided to the first chamber A through gaps provided between the outer rib 40 and the second plate 70. The gaps include a first gap 90 provided at a right rear end of the first chamber A and a second gap 91 provided at a left end of the expanded portion A1. The blowby gas G introduced into the first chamber A from the first gap 90 and the second gap 91 is guided to the openings 62 in the first plate 60 through the labyrinth structure formed by the partition walls 50.

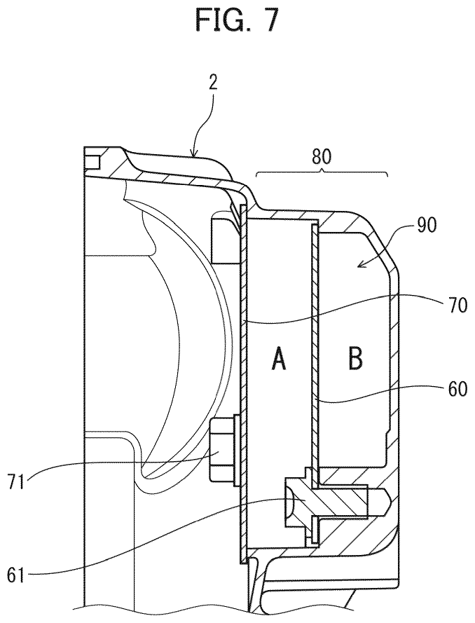

FIG. 7 is a sectional view along the line VII-VII in FIG. 6. As described above, the present invention is characterized in that the breather chamber 90 having the two-stage section 80 including the first chamber A and the second chamber B is configured by the first plate 60 being fixed with the bolts 61 and by the second plate 70 being fixed with the bolts 71 to the rear surface side of the cylinder head cover 2. In this manner, it is possible to provide the two-stage section 80 in the breather chamber 90, to increase the passage length inside the breather chamber, and to promote oil separation from the blowby gas G with a simple configuration in which the two plates are attached to the rear surface side of the cylinder head cover 2.

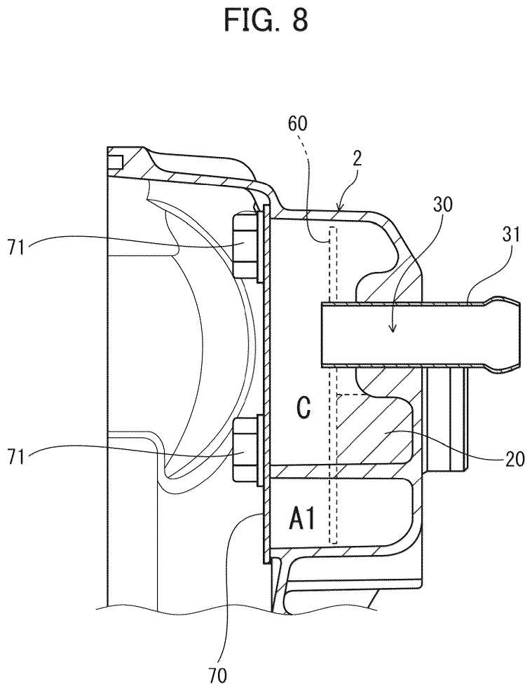

FIG. 8 is a sectional view along the line VIII-VIII in FIG. 6. Referring to FIG. 4 together, the third chamber C is disposed to be adjacent on the left side to the two-stage section 80 including the first chamber A and the second chamber B. The height dimension of the third chamber C in the cylinder axis direction is set to be greater than the height dimension of each of the first chamber A and the second chamber B. It is thus possible to reduce the amount by which the discharge pipe 31 provided in the third chamber C projects from the upper surface of the cylinder head cover 2.

In addition, the discharge pipe 31 is disposed at a position at which the discharge pipe 31 deviates from the communication passage 20 (see FIG. 5) in the front-rear direction and does not overlap each other in a view in the direction toward the second chamber B from the third chamber C. It is thus possible to lengthen the passage from the second chamber B to the discharge pipe 31 in the third chamber C. Furthermore, a lower end of the discharge pipe 31 is disposed at a position that is lower than the first plate 60, and it is thus possible to lengthen the passage, to reduce the amount by which the discharge pipe 31 projects from the cylinder head cover 2, and to reduce the size of the cylinder head cover 2.

FIG. 9 is a sectional view along the line IX-IX in FIG. 6. The communication passage 20 is formed of a through-hole provided through cutting from the upper side of the cylinder head cover 2, and a lid is put thereon by a cap member 22. In this manner, the blowby gas G passes through a gap provided between a bottom surface of the cap member 22 and a ceiling surface of the partition wall 21.

As described above, according to the breather chamber structure for an internal combustion engine of the present embodiment, it is possible to provide the two-stage section in the breather chamber 90, to increase the passage length inside the breather chamber, and to promote oil separation from the blowby gas with a simple configuration in which the two plates are attached to the rear surface side of the cylinder head cover 2 since the breather chamber 90 having the two-stage section 80 including the first chamber A and the second chamber B that are partitioned by the first plate 60, by the first plate 60 and the second plate 70 being attached to the rear surface side of the cylinder head cover 2 that is attached to the cylinder head 3 of the internal combustion engine 1 such that the first plate 60 and the second plate 70 are parallel with and spaced apart from each other is configured.

Note that the form of the internal combustion engine, the shape of the cylinder head cover, the shapes of the first chamber, the second chamber, and the third chamber, the shape of the partition walls for providing the labyrinth structures, the shapes and the materials of the first plate and the second plate, the attachment structure of the first plate and the second plate, and the like are not limited to those in the above embodiment, and various modifications can be made.

Although each of the first plate and the second plate is fixed with the bolts in the above embodiment, for example, a structure in which a bolt fastening structure is not used for the first plate and the second plate is fastened with bolts while pressing the first plate with a rib provided to stand from the second plate may be employed. With this configuration, it is possible to reduce the number of bolts and to configure a labyrinth structures by the rib for pressing the first plate. The breather chamber structure according to the present invention can be applied not only to an internal combustion engine mounted in a straddle-type vehicle such as a motorcycle or a three-wheeled vehicle but also various internal combustion engines used as drive sources for a ship, a cultivator, and the like.

### EXPLANATION OF REFERENCE NUMERALS

1 . . . Internal combustion engine, 2 . . . Cylinder head cover, 3 . . . Cylinder head, 20 . . . Communication passage, 31 . . . Discharge pipe, 60 . . . First plate, 70 . . . Second plate, 80 . . . Two-stage section, 90 . . . Breather chamber, G . . . Blowby gas, A . . . First chamber, B . . . Second chamber, C . . . Third chamber

What is claimed is:

1. A breather chamber structure for an internal combustion engine, the breather chamber structure being applicable to a breather chamber for temporarily storing, inside an internal combustion engine, blowby gas generated during operation of the internal combustion engine and to be recirculated to an intake passage,
the breather chamber structure comprising, in the breather chamber, a two-stage section formed by a first plate and a second plate that are attached to a rear surface side of a cylinder head cover attached to a cylinder head of the internal combustion engine and that are parallel with and spaced apart from each other, the two-stage section including a first chamber and a second chamber that are partitioned by the first plate.

2. The breather chamber structure according to claim 1, wherein
the breather chamber includes the first chamber into which the blowby gas is introduced first, the second chamber into which the blowby gas is introduced from the first chamber, and a third chamber into which the blowby gas is introduced from the second chamber,
the third chamber is disposed on a lateral side of the two-stage section,
the third chamber is provided with a discharge pipe that discharges the blowby gas to outside of the internal combustion engine, and
a height dimension of the third chamber is greater than a height dimension of each of the first chamber and the second chamber.

3. The breather chamber structure according to claim 2, further comprising:
a communication passage that establishes communication between the second chamber and the third chamber, wherein
the discharge pipe is disposed at a position at which the discharge pipe does not overlap with the communication passage when viewed in a direction from the third chamber toward the second chamber.

4. The breather chamber structure according to claim 3, wherein
a lower end of the discharge pipe is at a position lower than the first plate in a side view of the internal combustion engine.

5. The breather chamber structure according to claim 1, wherein
the second plate has a larger area than the first plate.
